(19) United States
(12) Patent Application Publication
(10) Pub. No.: US 2023/0098753 A1
(43) Pub. Date: Mar. 30, 2023

(54) 360-DEGREE PANORAMIC IMAGE ZOOM DISPLAY CAMERA

(71) Applicants: Nai-Wei HUANG, Taoyuan City (TW); Yi-Hao HUANG, Taoyuan City (TW)

(72) Inventors: Nai-Wei HUANG, Taoyuan City (TW); Yi-Hao HUANG, Taoyuan City (TW)

(21) Appl. No.: 17/827,773

(22) Filed: May 29, 2022

(30) Foreign Application Priority Data
Sep. 30, 2021 (TW) 110136496

(51) Int. Cl. H04N 5/232

(52) U.S. Cl. CPC H04N 5/23238; H04N 5/23296; H04N 5/2252

(57) ABSTRACT

A 360-degree panoramic image zoom display camera includes a 360-degree panoramic image zoom camera body composed of middle ring body, a left housing body and a right housing body, an image processing module, a first wide-angle lens module, a second wide-angle lens module, a dynamic zoom structure set in the 360-degree panoramic image zoom camera body, and a lens protector module. The dynamic zoom structure includes a lens module, and a driving module connected to the lens module to drive the lens module to move to a set focus position. The lens protector module and the dynamic zoom structure are used for photography to obtain partial images, and the depth focus is adjusted through the dynamic zoom structure.

### BACKGROUND OF THE INVENTION

### 1. Field of the Invention

The present invention relates to camera technology and more particularly to a 360-degree panoramic image zoom display camera.

### 2. Description of the Related Art

The surveillance industry has a place in today's society, from public construction and police security to private enterprise storefronts and factory warehouses, security surveillance equipment can be seen. The surveillance equipment records and monitors the status of a certain area by recording images, such as: intersections on the road, entrances and exits of warehouses, surrounding areas of exhibits, etc. When there is an accident occurs, the monitoring personnel can find or collect relevant information from the images recorded by the surveillance equipment. In addition to being used for security monitoring purposes, surveillance equipment with identification functions has also been developed, such as face recognition, object recognition, etc. At the same time, the identified objects can be tracked to understand the movement of the objects in this area.

Surveillance device configurations may include a number of surveillance devices such as cameras and infrared (IR) detectors. The surveillance device can be mounted on a support and can be used to monitor an area surrounding the surveillance device configuration. The surveillance devices in such a surveillance device configuration may all be of the same type or the surveillance devices may be of different types. For example, one surveillance device may be a fisheye camera and another surveillance device may be a fixed focal lens camera. In addition, the traditional fisheye type monitor is set on the ceiling, wall or floor to capture a wide scene with a fisheye lens to obtain all the image feature information within the monitoring range as much as possible. However, the angle of view of fisheye images is usually close to 180 degrees. Although the central area of the fisheye image can be conveniently viewed by the user, the side areas of the fisheye image are less conducive to viewing. The viewer needs to tilt his head sideways to view the side areas of the fisheye image in a way that is more in line with human visual perception. In addition, high-pixel fisheye images will reduce the frame rate of the camera, making it difficult to provide viewers with a smooth viewing experience.

### SUMMARY OF THE INVENTION

The present invention has been accomplished under the circumstances in view. It is therefore the main object of the present invention to provide a 360-degree panoramic image zoom display camera, which comprises a 360-degree panoramic image zoom camera body, an image processing module, a first wide-angle lens module, a second wide-angle lens module, a dynamic zoom structure, and a lens protector module. The 360-degree panoramic image zoom camera body is composed of a middle ring body, a left housing body and a right housing body. The middle ring body is arranged between the left housing body and the right housing body and the middle ring body is a 360-degree movable rotating member. The image processing module is installed inside the 360-degree panoramic image zoom camera body to receive the images obtained by photography and perform image processing. The first wide-angle lens module is arranged in the left housing body and connected to the image processing module. The first wide-angle lens module is used for photographing to obtain a first wide-angle image and transmit the first wide-angle image to the image processing module. The second wide-angle lens module is arranged in the right housing body and connected to the image processing module. The second wide-angle lens module is used for photographing to obtain a second wide-angle image and transmit the second wide-angle image to the image processing module. The dynamic zoom structure is set inside the 360-degree panoramic image zoom camera body and connected to the image processing module dynamic zoom structure. The dynamic zoom structure comprises at least one lens module and at least one driving module. The driving module is connected to the lens module and the driving module is used to drive the at least one lens module to move to a set focus position. The lens protector module is set on the middle ring body. The lens protector module and the dynamic zoom structure are used for photographing to obtain a partial image and transmit the partial image to the image processing module, wherein the depth focus is adjusted through the dynamic zoom structure.

Preferably, the 360-degree panoramic image zoom display camera further comprises a mounting structure. The mounting structure has one side thereof pivotally connected to the middle ring body.

Preferably, the 360-degree panoramic image zoom display camera further comprises a controller set inside the 360-degree panoramic image zoom camera body. The controller connects the middle ring body, the driving module, the image processing module and the mounting structure and controls the actions of the middle ring body, the driving module and the mounting structure.

Preferably, the dynamic zoom structure comprises a first inner ring body set inside the middle ring body. The first inner ring body comprises therein a plurality of first lenses and a first driver. The first driver is used to drive the first inner ring body to rotate, and the first inner ring body is a 360-degree movable rotating member.

Preferably, the dynamic zoom structure further comprises a second inner ring body set inside the first inner ring body. The second inner ring body comprises therein a plurality of second lenses and a second driver. The second driver is used to drive the second inner ring body to rotate, and the second inner ring body is a 360-degree movable rotating member.

Preferably, the dynamic zoom structure further comprises a third inner ring body set inside the third inner ring body. The third inner ring body comprises therein a plurality of third lenses and a third driver. The third driver is used to drive the third inner ring body to rotate, and the third inner ring body is a 360-degree movable rotating member. The first lenses, the second lenses and the third lenses form a lens module. The first driver, the second driver and the third driver form a driving module.

Preferably, the image processing module is located inside the third inner ring body.

Preferably, the middle ring body is a 360-degree movable horizontal axial rotating member, and the mounting structure is a 360-degree movable vertical axial rotating member.

To sum up, the 360-degree panoramic image zoom display camera disclosed by the present invention can bring the following effects:
1. It is able to photograph all the environment in all directions for real monitoring without blind spots, to prevent illegals from leaking blind spots and to achieve the goal of completely protecting personal safety and property.
2. Through the use of mobile devices, you can know whether suspicious persons appear, and you can quickly go to the incident site for processing. The inspection greatly reduces the time delay and increases the power of protection.
3. At the same time, it has the effect of wide-angle shooting and deep focus adjustment.

Below, it is easier to understand the purpose of the present invention, the technical content, the characteristics and the effect achieved by the detailed description of the specific embodiment.

### BRIEF DESCRIPTION OF THE DRAWINGS

FIG. 1 is a block diagram of the 360-degree panoramic image zoom display camera of the present invention.

FIG. 2 is a block diagram of the dynamic zoom structure of the 360-degree panoramic image zoom display camera of the present invention.

FIG. 3 is a schematic diagram of the appearance of the 360-degree panoramic image zoom display camera of the present invention.

FIG. 4. is a schematic diagram of the rotation action of the 360-degree panoramic image zoom display camera of the present invention.

FIG. 5 is a cross-sectional view of the dynamic zoom structure of the 360-degree panoramic image zoom display camera of the present invention.

FIG. 6 is a schematic diagram of the action of the dynamic zoom structure of the 360-degree panoramic image zoom display camera of the present invention.

### DETAILED DESCRIPTION OF THE PREFERRED EMBODIMENT

In order to solve many problems of existing surveillance cameras, after years of research and development by the inventor to improve the criticism of existing products, the following will introduce in detail how the present invention uses a 360-degree panoramic image zoom display camera to achieve the most efficient functional requirements.

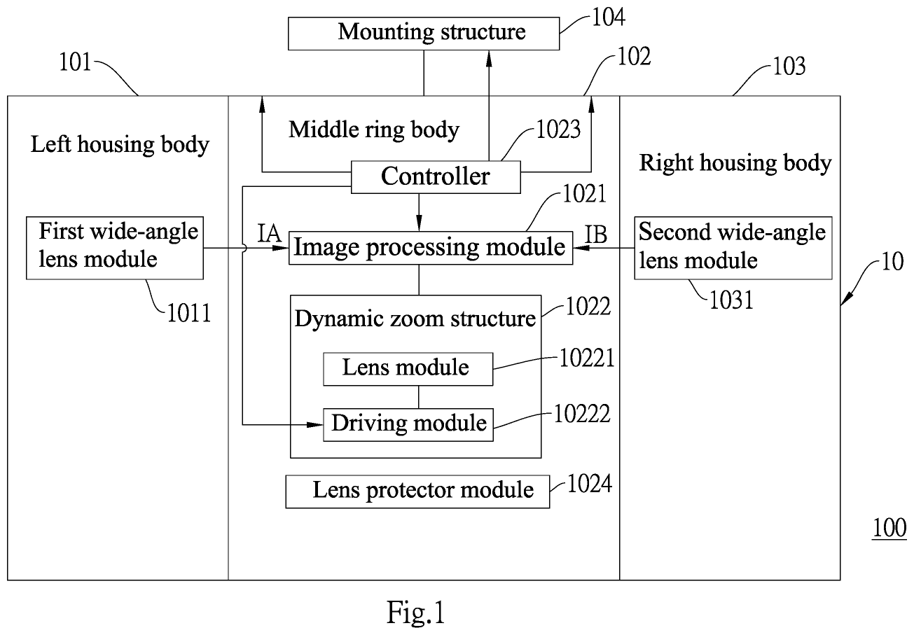

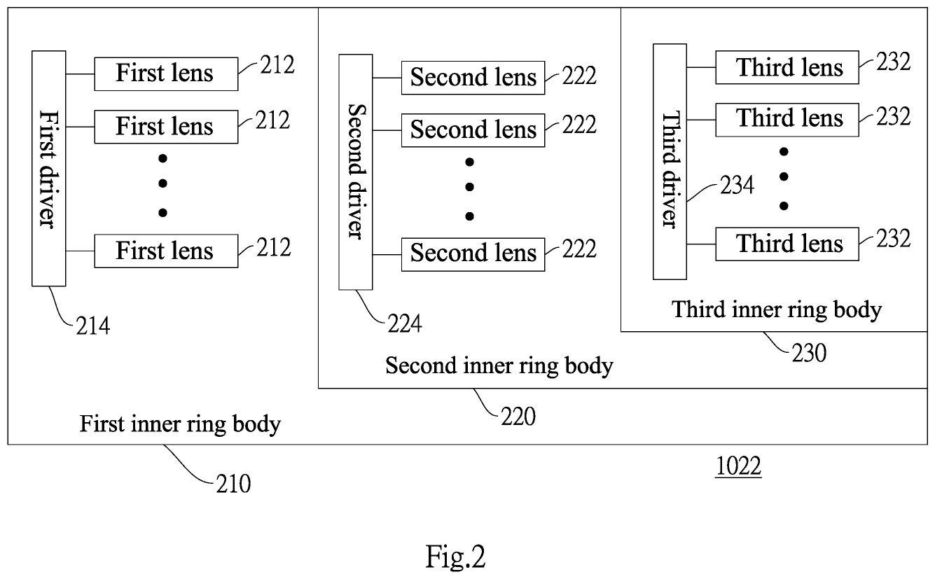

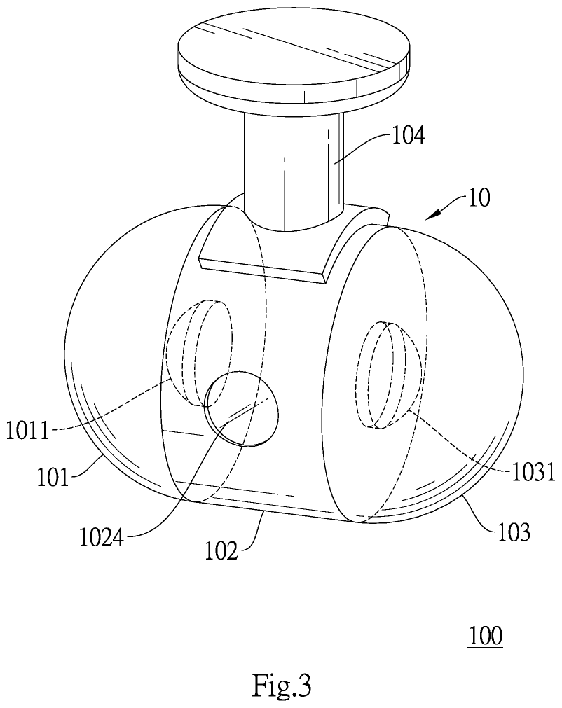

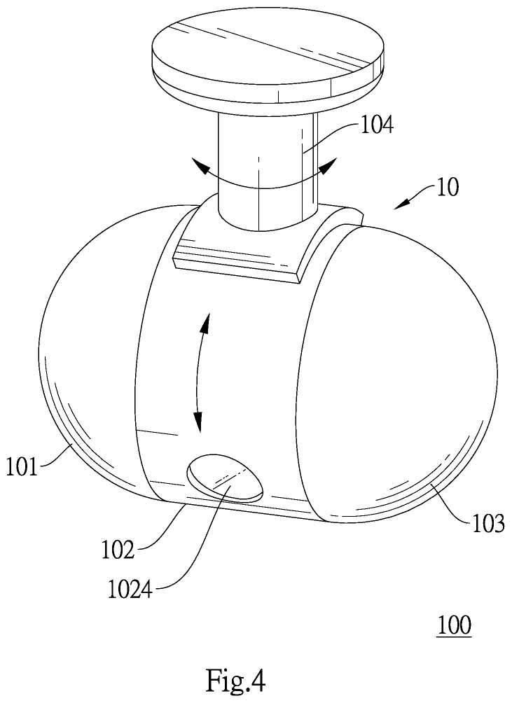

Please also refer to FIGS. 1 to 4, where FIG. 1 is a block diagram of the 360-degree panoramic image zoom display camera of the present invention, FIG. 2 is a block diagram of the dynamic zoom structure of the 360-degree panoramic image zoom display camera of the present invention, FIG. 3 is a schematic diagram of the appearance of the 360-degree panoramic image zoom display camera of the present invention, and FIG. 4. is a schematic diagram of the rotation action of the 360-degree panoramic image zoom display camera of the present invention. As shown in the drawings, in the embodiment of the present invention, the 360-degree panoramic image zoom display camera 100 comprises a 360-degree panoramic image zoom camera body 10, an image processing module 1021, a first wide-angle lens module 1011, a second wide-angle lens module 1031, a dynamic zoom structure 1022 and a lens protector module 1024. The 360-degree panoramic image zoom camera body 10 is composed of a middle ring body 102, a left housing body 101 and a right housing body 103. The middle ring body 102 is arranged between the left housing body 101 and the right housing body 103 and the middle ring body 102 is a 360-degree movable rotating member. The image processing module 1021 is arranged in the 360-degree panoramic image zoom camera body 10 to receive the images obtained by photography and perform image processing. The first wide-angle lens module 1011 is arranged in the left housing body 101 and is connected to the image processing module 1021. The first wide-angle lens module 1011 is used for photographing to obtain a first wide-angle image IA and transmits the first wide-angle image IA to the image processing module 1021 for image processing. The second wide-angle lens module 1031 is arranged in the right housing body 103 and is connected to the image processing module 1021. The second wide-angle lens module 1031 is used for photographing to obtain a second wide-angle image IB and transmits the second wide-angle image IB to the image processing module 1021 for image processing. The first wide-angle lens module 1011 and the second wide-angle lens module 1031 in the above can be fisheye lens modules. It is particularly noted that the 360-degree panoramic image generation in the embodiment of the present invention comes from the combination of the first wide-angle image IA and the second wide-angle image IB.

Furthermore, the dynamic zoom structure 1022 is set inside the 360-degree panoramic image zoom camera body 10 and connected to the image processing module 1021. The dynamic zoom structure 1022 comprises at least one lens module 10221 and at least one driving module 10222. The driving module 10222 is connected to the lens module 10221, and the driving module 10222 is used to drive the lens modules 10221 to move to a set focus position, which is usually the function of adjusting the depth focus to zoom in or zoom out. It can also be done alone. The lens protector module 1024 is arranged outside the middle ring body 102. The lens protector module 1024 and the dynamic zoom structure 1022 are used for photographing to obtain a partial image and send the partial image to the image processing module 1021 for image processing, wherein the depth focus is adjusted through the dynamic zoom structure 1022. In addition, in the embodiment of the present invention, the 360-degree panoramic image zoom display camera 100 further comprises a mounting structure 104 and a controller 1023. One side of the mounting structure 104 is pivotally connected to the middle ring body 102 and the other side of the mounting structure 104 is installed according to user requirements.

The controller 1023 is set inside the 360-degree panoramic image zoom camera body 10. The controller 1023 connects the middle ring body 102, the driving module 10222, the image processing module 1021 and the mounting structure 104. The controller 1023 can control the actions of the middle ring body 102, the driving module 10222 and the mounting structure 104, such as adjusting the viewing angle or the pitch angle of the middle ring body 102 for shooting images, or for example, adjusting the horizontal rotation angle through the mounting structure 104. It is worth noting that in the embodiment of the present invention, the middle ring body 102 is a 360-degree movable horizontal axial rotating member, and the mounting structure 104 is a 360-degree movable vertical axial rotating member, all of which are controlled by the controller 1023 to rotate. In a live broadcast platform application scenario, the user can not only watch the panoramic image but also obtain the temporary control right (acquisition of permission) of the 360-degree panoramic image zoom display camera 100 according to the embodiment of the present invention through an application program (commonly known as APP) of a payment mechanism and You can operate the zoom in or zoom out function to further view or shoot images.

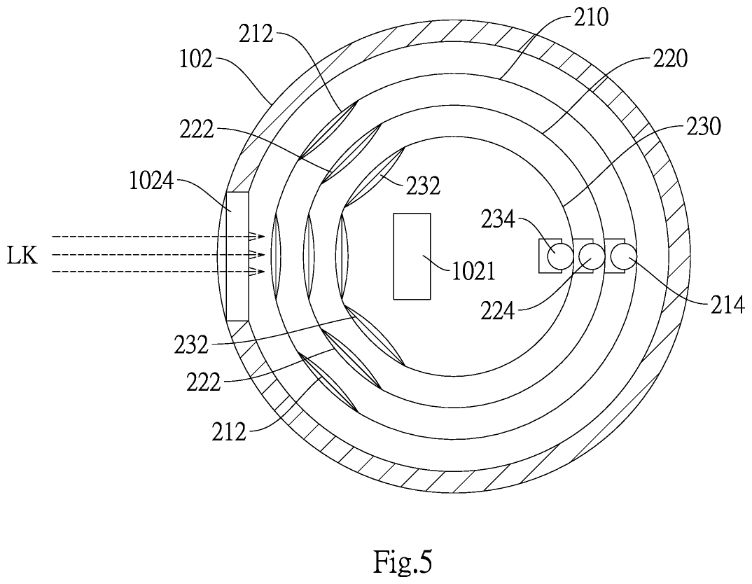

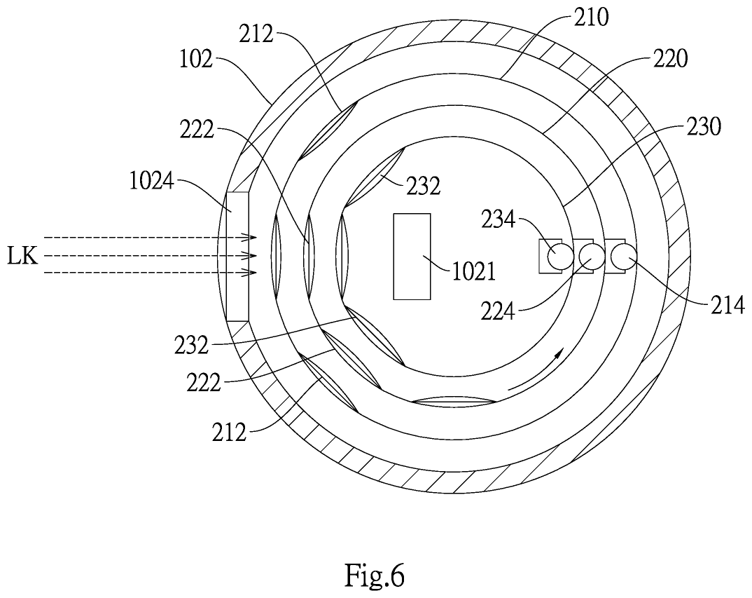

For details, please refer to FIG. 2, FIG. 5 and FIG. 6 at the same time, where FIG. 5 is a cross-sectional view of the dynamic zoom structure of the 360-degree panoramic image zoom display camera of the present invention and FIG. 6 is a schematic diagram of the action of the dynamic zoom structure of the 360-degree panoramic image zoom display camera of the present invention. In the embodiment of the present invention, the dynamic zoom structure 1022 comprises a first inner ring body 210, a second inner ring body 220 and a third inner ring body 230. The first inner ring body 210 is disposed on the inner side of the middle ring body 102 and the first inner ring body 210 comprises a plurality of first lenses 212 and a first driver 214. The first driver 214 is used to drive the first inner ring body 210 to rotate and the first inner ring body 210 is a 360-degree movable rotating member. The second inner ring body 220 is set inside the first inner ring body 210. The second inner ring body 220 comprises therein a plurality of second lenses 222 and a second driver 224. The second driver 224 is used to drive the second inner ring body 220 to rotate and the second inner ring body 220 is a 360-degree movable rotating member. The third inner ring body 230 is arranged inside the second inner ring body 220. The third inner ring body 230 comprises therein a plurality of third lenses 232 and a third driver 234. The third driver 234 is used to drive the third inner ring body 230 to rotate and the third inner ring body 230 is a 360-degree movable rotating member. The first lenses 212, the second lenses 222 and the third lenses 232 are the lens module 10221, and the first driver 214, the second driver 224 and the third driver 234 are the driving module 10222. In an exemplary embodiment, the image processing module 1021 is located inside the third inner ring body 230. It should be noted that the 360-degree panoramic image zoom display camera 100 according to the embodiment of the present invention can maintain a 360-degree panoramic image shooting in a fixed direction through an algorithm, and then use zoom in or zoom out to view the image.

For example, when the 360-degree panoramic image zoom display camera 100 takes pictures of the environment through the first wide-angle lens module 1011 on the left housing body 101 and the second wide-angle lens module 1031 on the right housing body 103, it can fully display 360-degree panoramic images to the screen of the user's device. The image frame can be sent to the screen on the device in real time through wired or wireless means for display, and the image frame can also be sent to a cloud server for image recognition analysis or to the cloud database for periodic storage. When a user or an internal program setting detects and locks a target, the controller 1023 of the 360-degree panoramic image zoom display camera 100 rotates the mounting structure 104 and the middle ring body 102 to align with the target. Afterwards, according to the user's operation or internal program setting, the 360-degree panoramic image zoom display camera 100 will operate the dynamic zoom structure through the controller 1023 to adjust the depth focus (zoom in or zoom out), letting the light passes through the lens protector module 1024, the first lenses 212, the second lenses 222 or the third lenses 232 to the image processing module 1021. That is to say, the controller 1023 will control the first driver 214, the second driver 224 or the third driver 234 to drive the first inner ring body 210, the second inner ring body 220 or the third inner ring body 230 respectively according to the received command, so that the first lenses 212, the second lenses 222 or the third lenses 232 can be moved to a certain set focal length position to achieve the effect of zooming in or zooming out, and partial images of the target can also be obtained for analysis and identification. That is to say, the adjustment of depth focal length is achieved through the arrangement and combination of different internal lenses. The 360-degree panoramic image zoom display camera 100 of the embodiment of the present invention can be applied to many surveillance photography situations such as: home, factory, office, or any public space, but the embodiment of the present invention is not limited by this.

To sum up, the 360-degree panoramic image zoom display camera disclosed by the present invention can bring the following effects:
1. It is able to photograph all the environment in all directions for real monitoring without blind spots, to prevent illegals from leaking blind spots and to achieve the goal of completely protecting personal safety and property.
2. Through the use of mobile devices, you can know whether suspicious persons appear, and you can quickly go to the incident site for processing. The inspection greatly reduces the time delay and increases the power of protection.
3. At the same time, it has the effect of wide-angle shooting and deep focus adjustment.

What the invention claimed is:

1. A 360-degree panoramic image zoom display camera, comprising:
a 360-degree panoramic image zoom camera body composed of a middle ring body, a left housing body and a right housing body, said middle ring body being arranged between said left housing body and said right housing body and said middle ring body being a 360-degree movable rotating member;
an image processing module installed inside said 360-degree panoramic image zoom camera body to receive the images obtained by photography and perform image processing;
a first wide-angle lens module arranged in said left housing body and connected to said image processing module, said first wide-angle lens module being used for photographing to obtain a first wide-angle image and transmit said first wide-angle image to said image processing module;
a second wide-angle lens module arranged in said right housing body and connected to said image processing module, said second wide-angle lens module being used for photographing to obtain a second wide-angle image and transmit said second wide-angle image to said image processing module;
a dynamic zoom structure set inside said 360-degree panoramic image zoom camera body and connected to said image processing module dynamic zoom structure, said dynamic zoom structure comprising at least one lens module and at least one driving module, said driving module being connected to said lens module and said driving module being used to drive said at least one lens module to move to a set focus position; and
a lens protector module set on said middle ring body, said lens protector module and said dynamic zoom structure being used for photographing to obtain a partial image and transmit said partial image to said image processing module, wherein the depth focus is adjusted through said dynamic zoom structure.

2. The 360-degree panoramic image zoom display camera as claimed in claim 1, further comprising a mounting structure, said mounting structure having one side thereof pivotally connected to said middle ring body.

3. The 360-degree panoramic image zoom display camera as claimed in claim 2, further comprising a controller set inside said 360-degree panoramic image zoom camera body, said controller connecting said middle ring body, said driving module, said image processing module and said mounting structure and controlling the actions of said middle ring body, said driving module and said mounting structure.

4. The 360-degree panoramic image zoom display camera as claimed in claim 1, wherein said dynamic zoom structure comprises a first inner ring body set inside said middle ring body, said first inner ring body comprising therein a plurality of first lenses and a first driver, said first driver being used to drive said first inner ring body to rotate and said first inner ring body being a 360-degree movable rotating member.

5. The 360-degree panoramic image zoom display camera as claimed in claim 4, wherein said dynamic zoom structure further comprises a second inner ring body set inside said first inner ring body, said second inner ring body comprising therein a plurality of second lenses and a second driver, said second driver being used to drive said second inner ring body to rotate and said second inner ring body being a 360-degree movable rotating member.

6. The 360-degree panoramic image zoom display camera as claimed in claim 5, wherein said dynamic zoom structure further comprises a third inner ring body set inside said third inner ring body, said third inner ring body comprising therein a plurality of third lenses and a third driver, said third driver being used to drive said third inner ring body to rotate and said third inner ring body being a 360-degree movable rotating member, said first lenses, said second lenses and said third lenses forming one said lens module, said first driver, said second driver and said third driver forming one said driving module.

7. The 360-degree panoramic image zoom display camera as claimed in claim 6, wherein said image processing module is located inside said third inner ring body.

8. The 360-degree panoramic image zoom display camera as claimed in claim 1, wherein said middle ring body is a 360-degree movable horizontal axial rotating member, and said mounting structure is a 360-degree movable vertical axial rotating member.
